(19) United States
(12) Patent Application Publication
(10) Pub. No.: US 2023/0161644 A1
(43) Pub. Date: May 25, 2023

(54) CALL MODIFICATION BASED ON POLICIES

(71) Applicant: Hewlett-Packard Development Company, L.P., Spring, TX (US)

(72) Inventors: Christoph Graham, Spring, TX (US); Thomas R. Gawlik, Spring, TX (US)

(73) Assignee: Hewlett-Packard Development Company, L.P., Spring, TX (US)

(21) Appl. No.: 17/921,114

(22) PCT Filed: May 21, 2020
(86) PCT No.: PCT/US2020/033946

§ 371 Date: Oct. 25, 2022

(51) Int. Cl. G06F 9/54

(52) U.S. Cl. CPC G06F 9/541

(57) ABSTRACT

In some examples, a computing device can include a memory resource storing instructions to cause a processor resource to receive a call from an application to an application programming interface (API) service of an operating system (OS) of the computing device, modify the call to the API service based on a policy, and return a modified output to the application according to the modified call based on the policy being active.

### BACKGROUND

A computing device can allow a user to utilize computing device operations for work, education, gaming, multimedia, and/or other uses. Computing devices can be utilized in a non-portable setting, such as at a desktop, and/or be portable to allow a user to carry of otherwise bring with the computing device with while in a mobile setting.

### BRIEF DESCRIPTION OF THE DRAWINGS

FIG. 1 is an example of a computing device for call modification based on policies.

FIG. 2 illustrates an example of a computing device for call modification based on policies.

FIG. 3 illustrates a block diagram of an example system for call modification based on policies.

FIG. 4 illustrates an example of a method for call modification based on policies.

### DETAILED DESCRIPTION

A user may utilize a computing device for various purposes, such as for business and/or recreational use. As used herein, the term “computing device” refers to an electronic system having a processor resource and a memory resource. Examples of computing devices can include, for instance, a laptop computer, a notebook computer, a desktop computer, networking device (e.g., router, switch, etc.), and/or a mobile device (e.g., a smart phone, tablet, personal digital assistant, smart glasses, a wrist-worn device, etc.), among other types of computing devices. As used herein, a mobile device can include devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices.

A user may utilize their computing device for both business and recreational use. For example, a user may utilize their computing device while in an office setting or a school setting, as well as utilize their computing device in a home setting for work or school etc. Additionally, the user may utilize their computing device at their home and/or in other locations for recreational use.

Accordingly, a user experience of the computing device can be tailored based on the type of use of the computing device, the location of the computing device, external stimuli detected by the computing device, etc. As used herein, the term “user experience” refers to an overall instance of a user encountering, interacting, and/or otherwise interfacing with a computing device. For example, the user experience of a user can be shaped according to how a user experiences the computing device in a given context.

The user experience of the computing device may be tailored for a user based on whether the user is utilizing the computing device for work, school, or recreational use, the location of the computing device, and/or other external stimuli. Such customization can allow for separation of work/school and recreational/leisure use, which can positively tailor the user experience of the computing device, for example. Additionally, such customization can allow for a negatively tailored user experience for a user which may be beneficial, such as parental controls.

In some examples, the user experience may be tailored at an application level. For example, some applications can be tailored to behave differently when the computing device is used for work rather than for recreational use and/or vice versa. However, each individual application may have to be modified. Additionally, some applications may not be able to handle such modification.

In some examples, the user experience may be tailored by a separation-based approach. For instance, session boundaries within an operating system may be relied on, such as different user accounts, in order to tailor the user experience based on which user account is logged in to an instance of the operating system. For example, applications may behave differently based on a user being logged in to a work account, where the behavior of the application may change based on the user logging into a recreational account. As another example, hardware-based separation may be utilized including operating system virtualization and/or physical separation. For instance, applications may behave differently based on one boot partition being utilized, where the behavior of the application may change based on a different boot partition being utilized. However, such approaches may not apply to all applications, as certain applications may not be able to handle such a separation-based approach.

Call modification based on policies, according to the disclosure, can allow for tailoring of a user experience by changing inputs to applications using an application programming interface (API) that applications use to communicate with an operating system of a computing device. That is, a call from an application to the operating system may be modified, and the modified call can be returned to the application to modify behavior of the application. Modification of the call can be done according to different policies that can be activated, where certain policies can be activated according to external stimuli detected by the computing device. Such an approach can leverage common interfaces in order to tailor a user experience across all applications and/or different operating systems without individually modifying applications themselves, for example.

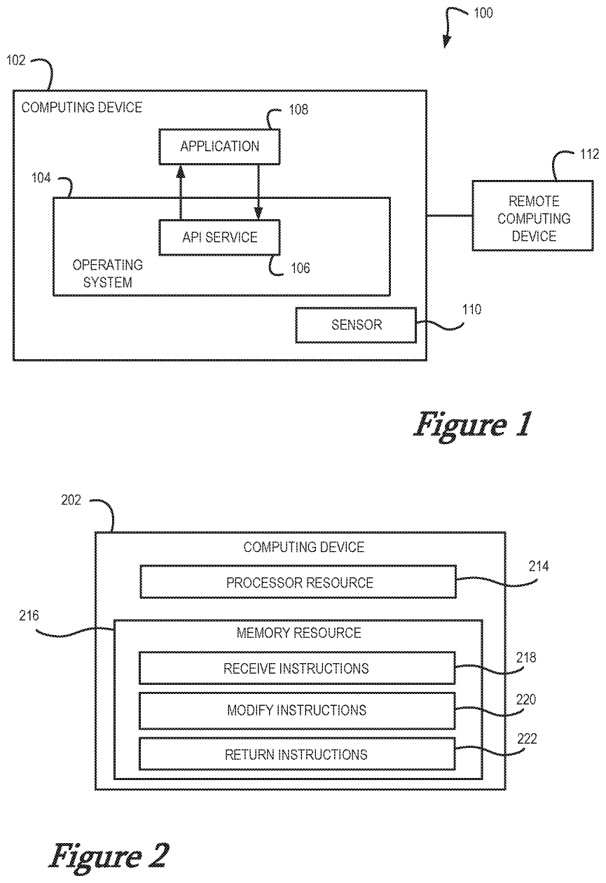

FIG. 1 is an example of a computing device 102 for call modification based on policies. The computing device 102 can include an operating system 104, an application 108, and a sensor 110. The operating system 104 can include an API service 106, The computing device 102 can be connected to a remote computing device 112.

As illustrated in FIG. 1, the computing device 102 can include an operating system 104. As used herein, the term “operating system” refers to a management application that manages computing device hardware, computing resources, and provides services for applications. For example, the operating system (e.g., OS) 104 can manage hardware such as a motherboard, power supply, drives (e.g., floppy, optical (CD-ROM, CD-RW, DVD-ROM, etc.)), hard disk, video card, sound card, peripheral devices (e.g., keyboard, touchpad, mouse, etc.), among other hardware components.

The OS 104 can, for example, also provide services such as an API service 106. As used herein, the term “API service” refers to an interface between an operating system and an application that provides the application a description of how to interact with the operating system in order to retrieve and/or change data within the OS. For example, the API service 106 can provide an interface between the OS 104 and the application 108. Such an interface provided by the API service 106 can allow for the application 108 to interact with the OS 104. For instance, the API service 106 can provide the application 108 with a description of how to access a registry of the OS 104, among other examples.

The API service 106 can provide services to an application 108. As used herein, the term “application” refers to a collection of instructions that can be executed by a processor resource. An application can be executed by a processor resource to perform a task. For example, the task can be, for example, word processing, providing/manipulating spreadsheets, browsing the Internet, viewing files, playing media, etc.

Although the application 108 is described as a word processor, a spreadsheet, a web browser, email client, media player, file viewer, and/or a game, examples of the disclosure are not so limited. For example, the application 108 can be any other type of application designed to perform any type of task.

Although the computing device 102 is illustrated in FIG. 1 as including a single application 108, examples of the disclosure are not so limited. For example, the computing device 102 can include more than one application.

The OS 104 can receive a call from the application 108 to the API service 106. As used herein, the term “call” refers to a request from an application for a service from an operating system, For example, the application 108 can transmit a call to the API service 106 of the OS 104 for a service.

In some examples, the call can be a system call. For example, the system call can be a process control call (e.g., end and abort, load and execute, create or terminate process, wait event, signal event, allocate and free memory, etc.), a file management call (create a file, delete a file, open and close a file, read, write, reposition, get and set file attributes, etc.), a device management call (request or release device, logically attach or detach device, get and set device attributes, etc.), an information maintenance call (get or set time or date, get process or device attributes, etc.), and/or a communication call (create/delete communication connections, send or receive messages, etc.), among other types of system calls. Such system calls can be generated in order to access, by the application 108, the registry of the OS 104 (e.g., via a registry request), access a file (e.g., via a file request), access a different API (e.g., via an API request), access a network location (e.g., via a network request), and/or access hardware (e.g., graphics/drawing input/output (I/O)) of the computing device 102 (e.g., via a hardware request), etc.

For example, the application 108 may be a web browser and can generate a system call (e.g,, such as a communication call) to transmit to the OS 104 in order for the web browser to access a particular uniform resource locator (URL). For instance, a user can perform a web search by entering a search term into a web browser, and in response the web browser can generate the system call and transmit the system call to the API service 106 of the OS 104 in order to access a URL based on the web search by the user. The API service 106 can receive the system call from the application 108.

The computing device 102 can hook the system call to the API service 106. As used herein, the term “hook” (or “hooking”) refers to techniques to intercept a system call passed between an application and an operating system. The system call can be hooked by a function provider included in the API service 106. As used herein, the term “function provider” refers to a service that provides instructions to perform a task. For example, the function provider included in the API service 106 can provide instructions to hook a system call received from the application 108. The system call can be hooked by the function provider of the API service 106 to be modified in order to augment or modify the behavior of the application 108 and/or the OS 104, as is further described herein.

As illustrated in FIG. 1, the computing device 102 can include a sensor 110. As used herein, the term “sensor” refers to a device to detect an event or change in its environment and, in response, transmit information. For example, the sensor 110 can detect changes in and/or around the environment of computing device 102 and can transmit information related to the change to a processor resource of the computing device 102. Examples of sensors can include, for instance, motion sensors, temperature sensors, sound sensors, moisture/humidity sensors, pressure sensors, altitude sensors, gas sensors, light sensors, cameras, location sensors, among other types of sensors.

The sensor 110 can capture sensor data. For example, the sensor 110 can be a light sensor which can be utilized to capture data about lighting conditions in and/or around the environment of computing device 102, among other examples.

Although the computing device 102 is illustrated in FIG. 1 as including a single sensor 110, examples of the disclosure are not so limited. For example, the computing device 102 can include more than one sensor.

Based on the captured sensor data by the sensor 110, the computing device can activate a policy. As used herein, the term “policy” refers to a predetermined procedure that is to occur when a condition associated with the policy is satisfied. A policy can be active when the condition associated with the policy is satisfied. The condition may be determined to be satisfied based on detected changes in and/or around the environment of the computing device 102 by the sensor 110. For example, a policy can be include an action to be taken by the function provider of the API service 106 in response to a condition being satisfied.. The condition can be, for instance, a contingent circumstance satisfied by sensor data captured by the sensor 110, For example, a policy can include changing a color temperature of a display device of the computing device 102 based on an amount of light in an environment of the computing device 102 detected by the sensor 110 (e.g., in order for the display device to emit less blue light to a user's eyes), among other types of policies,

A policy may be an inactive policy. For example, a policy may include a condition that is not satisfied by sensor data captured by the sensor 110. For example, a policy can include changing a color temperature of a display device of the computing device 102 in response to an amount of light captured by the sensor 110 exceeding a threshold amount of light. If the sensor 110 captures an amount of light that does not exceed the threshold amount of light, the policy can be determined to be inactive. In such an example, the color temperature of the display device is not changed.

Although a single policy is described above, examples of the disclosure are not so limited. For example, the computing device 102 can include more than one policy. The policies can be stored locally (e.g., on the computing device 102) or remotely (e.g., at the remote computing device 112).

The computing device 102 can modify the call to the API service 106 from the application 108 based on the policy. For example, the application 108 can transmit a call to the API service 106 of the OS 104, and the function provider in the API service 106 can hook the transmitted call for modification, Modifying the call can include filtering the call, altering the call, and/or prioritizing a first content type over a second content type, as is further described herein.

The computing device 104 can modify the call according to the policy by filtering the call, As used herein, the term “filter” refers to directing a request intended for a first location to a second location based on a condition. For example, the call can be a call to the registry of the OS 104 and the function provider of the API service 106 can filter the call from one location of the registry to a second location in the registry according to an active policy. For instance, in response to a policy (e.g., the computing device 102 being in a particular geospatial location, the computing device 102 being connected to a particular network type, and/or the particular network type security), the function provider can filter the call so that it accesses a second registry location rather than a first location, where the sensor 110 can detect whether the conditions of the policy are satisfied (e.g., the geospatial location, the type of network, the network security, etc.).

In some examples, the computing device 104 can modify the call to the API service 106 by altering the filtered call. As used herein, the term “alter” refers to changing a characteristic or value of an object. For example, a policy can include URL redirection based on location of the computing device 102. For instance, a company may include a web portal to access the company network via a first URL (e.g., while in the United States) or a second URL (while outside the United States) according to a country the computing device 102 is attempting to access the company network from. The application 108 may be a web browser which receives a first URL from a user input, and the application 108 can transmit a call to the API service 106 to cause the computing device 102 to cause the web browser to access the first URL. The function provider of the API service 106 can alter the filtered call in response to the sensor 110 determining the computing device 102 is outside of the United States such that the web browser accesses the second URL, where the second URL may include stricter security protocols, may be country specific, etc.

In some examples, the computing device 102 can modify the call to the API service 106 by prioritizing a first content type over a second content type. As used herein, the term “content type” refers to a characteristic that describes information. For example, a policy can include categories of search results that are accessible based on certain conditions being satisfied (e,g., geolocation of computing device 102, time of day, etc.). For instance, a company may include a policy that allows certain web browser search results to be inaccessible during normal work hours (e.g., 9 AM to 5 PM). In response to a user inputting search term(s) into the application 108 (e.g., a web browser), the web browser can transmit a call to the API service 106 to cause the computing device 102 to cause the web browser to search the terms on the Internet. The function provider of the API service 106 can modify the call by prioritizing to a user of the computing device 102 certain search results to be displayed to the user, such as educational search results, and blocking other search results from being displayed to the user if the particular time of day falls within the work hours defined by the policy, such as search results including entertainment or other results that may not be something the user should be searching for during a work day, As another example, the application 108 may be a local file-system search on the computing device 102, and in response to the user inputting search term(s), the function provider of the API service 106 can modify the call by prioritizing to the user work related applications (e.g., a word processor application, spreadsheet application, etc.) and blocking other search results from being displayed to the user (e.g., games, media applications, etc.) if the particular time of day falls within the work hours defined by the policy.

Modifying the hooked system call can include adding a parameter to the hooked system call. As used herein, the term “parameter” refers to a variable to pass information between functions or procedures. For example, the function provider of the API service 106 can add a parameter to the system call. The parameter can, in some examples, cause the system call to be filtered, altered, and/or prioritize certain content types over other content types when the system call accesses the OS 104 or when an output is returned to the application 108.

Modifying the hooked system call can include adding a flag to the hooked system call. As used herein, the term “flag” refers to a value that acts as a signal for a function or process. For example, the function provider of the API service 106 can add a flag to the system call to cause the system call to be filtered, altered, and/or prioritize certain content types over other content types when the system call calls for another API in the OS 104.

The computing device 102 can return a modified output to the application 108 according to the modified call based on the policy being active. For example, after the function provider of the API service 106 modifies the call, an output can be returned to the application 108 that causes a change in behavior of the application 108 according to the modified call.

The application 108 can execute according to the modified output. As used herein, the term “execute” refers to the process by which a processor resource executes instructions of an application. The modified output (e.g., as a result of the hooked and modified call to the OS 104) can cause the process by which the computing device 102 executes the instructions of application 108 to be modified, as is further described herein.

For example, the computing device 102 can include a policy in which the color temperature of a display device of the computing device 102 can be changed based on a time of day, a user usage pattern, an amount of light in an environment of the computing device 102, etc. In response to the sensor 110 determining the color temperature of the display device should be changed (e.g., the sensor 110 determines that it is a time of day in which the color temperature should be changed such as after 5 PM, the sensor determines a user has been using the computing device 102 for an amount of time that exceeds a threshold amount of time, the sensor 110 determines an amount of light in the environment of the computing device 102 is below a threshold amount, etc.), the computing device 102 can cause the policy to be active, The API service 106 can receive a system call from the application 108, and the function provider of the API service 106 can hook the received system call and modify the hooked system call based on the active policy (e.g., by adding a parameter and/or a flag to the hooked system call). The modified system call can access the OS 104 and/or be returned to the application 108 as a modified output, where the application 108 can execute according to the modified output (e.g., causing the display device to change color temperature).

Although the computing device 102 is described above as hooking a system call to change a color temperature of a display device of the computing device 102, examples of the disclosure are not so limited. For example, the computing device 102 can hook and modify a system call from the application 108 to enforce an airplane mode (e.g., based on a sensed cabin pressure, altitude, geolocation, etc.), changing available features based on the computing device 102 being inside or outside a particular geospatial domain, utilizing communication frequencies that correspond to certain geographic regions (e.g., using frequencies that comply with regulatory codes in the United States, in Europe, etc.), ensuring a particular security type and/or level is activated or deactivated based on a type of network (e.g., public, private, local, wireless, etc.), enabling or disabling restrictions on particular websites a web browser can access according to time of day, network type, etc., preventing certain applications of the computing device 102 or remote from the computing device 102 from being executed (e.g., based on particular time of day, geolocation of computing device 102, etc.), changing search results behavior from websites (e.g., when the application 108 is a web browser) or locally on the computing device 102 (e,g., when the application 108 is a file explorer), causing fonts to be bolded after a certain amount of use time of the computing device 102, among other examples.

In some examples, the computing device 102 can receive updated policies. For example, a company may update a policy so that users of computing devices having the policy are redirected from a first URL of a web portal to access the company network to a second URL of a more secure web portal to access the company network when the computing device 102 is located outside of the United States. The updated policy may be transmitted to the computing device 102 from the remote computing device 112. The updated policy may be transmitted to the computing device 102 via a wired or wireless connection,

The wired or wireless network connection can be a network relationship that connects the computing device 102 to the remote computing device 112. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WiMAX), infrared (IR) communication, Public Switched Telephone Network (PSTN), radio waves, and/or the Internet, among other types of network relationships.

In some examples, the computing device 102 can include a user account. As used herein, the term “user account” refers to an identity created for a user in a computing system. For example, the computing device 102 can include a first user account for a first user of the computing device 102 and a second user account for a second user of the computing device 102. Each user account can include a unique username and/or password and can identify a particular user to the computing device 102.

Each user account can be associated with policies. For example, a first user may utilize the computing device 102 in a work capacity which can include policies that allow for the computing device 102 to operate in a secure manner, that promote productivity, etc. A second user may utilize the computing device 102 in a leisure capacity which can include policies that may be the same or different from the first user account. Policies may overlap between the user accounts. For example, certain policies may be present on both the first user account and the second user account. However, examples of the disclosure are not so limited. For example, the first user account may include a first set of policies and the second user account may include a second set of policies, where the first set of policies are different from the second set of policies.

In response to a user account accessing the computing device 102, the computing device 102 can retrieve and employ the policies associated with the user account of the computing device 102. For example, the first user account can include a policy to bold fonts after a certain amount of use time, and in response to the sensor 110 detecting the amount of use time exceeds a threshold amount of use time, the function provider of the API service 106 can hook and modify a system call from the application 108 to cause the application 108 to bold fonts. Additionally, the second user account can include a policy to turn on airplane mode of the computing device 102 when the sensor 110 detects the computing device 102 is on board an aircraft and in response to the sensor 110 detecting the computing device 102 being on board an aircraft, the function provider of the API service 106 can hook and modify a system call from the application 108 to cause the application 108 to enable airplane mode of the computing device 102.

As described above, in some examples, certain policies may be present on both the first user account and the second user account. For example, both the first user account and the second user account can include a policy to change available features based on the computing device 102 being inside or outside a particular geospatial domain. The first user account may be an employee account on the computing device 102 having a policy to change accessibility of a file system based on whether the computing device 102 is located within an office building. The second user account may be an administrative account on the computing device 102 also including the policy to change accessibility of a file system based on whether the computing device 102 is located within the office building. However, the second user account may include different permission levels than the first user account, When the first user account is logged into the computing device 102 and the computing device 102 is located within the office building, the function provider of the API service 106 can hook and modify a system call from the application 108 (e.g., a file system viewer) to allow the accessible portion of the file system, When the second user account is logged into the computing device 102 and the computing device 102 is located within the office building, the function provider of the API service 106 can refrain from hooking and modifying the system call, allowing the file system viewer to access the whole file system.

Call modification based on policies, according to the disclosure, can allow for a user experience of a computing device to be tailored by modifying calls from an application to an API service and returning a modified output that causes the application to change its behavior. Modification of the behavior of an application can be based on a policy that is activated according to a sensor. Such an approach can allow for the modification of application behavior without modifying the application itself by utilizing interfaces between the application and the operating system of the computing device. Accordingly, individual applications do not have to be modified in order to modify their behavior, allowing application behavior to be modified across other types of operating systems. In other words, a user experience can be modified across different operating systems and/or different applications in a secure and efficient manner.

FIG. 2 illustrates an example of a computing device 202 for call modification based on policies. As described herein, the computing device 202 may perform functions related to call modification based on policies, Although not illustrated in FIG. 2, the computing device 202 may include a processor and a non-transitory machine-readable storage medium. Although the following descriptions refer to a single processor and a single machine-readable storage medium, the descriptions may also apply to a system with multiple processors and multiple machine-readable storage mediums. In such examples, the computing device 202 may be distributed across multiple non-transitory machine-readable storage mediums and across multiple processors. Put another way, the instructions executed by the computing device 202 may be stored across multiple machine-readable storage mediums and executed across multiple processors, such as in a distributed or virtual computing environment.

Processor resource 214 may be a central processing unit (CPU), a semiconductor-based microprocessor, and/or other hardware devices suitable for retrieval and execution of machine-readable instructions 218, 220, 222 stored in a memory resource 216. Processor resource 214 may fetch, decode, and execute instructions 218, 220, 222. As an alternative or in addition to retrieving and executing instructions 218, 220, 222, processor resource 214 may include a plurality of electronic circuits that include electronic components for performing the functionality of instructions 218, 220, 222.

Memory resource 216 may be any electronic, magnetic, optical, or other physical storage device that stores executable instructions 218, 220, 222 and/or data. Thus, memory resource 216 may be, for example, Random-Access Memory (RAM), an Electrically-Erasable Programmable Read-Only Memory (EEPROM), a storage drive, an optical disc, and the like, Memory resource 216 may be disposed within computing device 202, as shown in FIG. 2. Additionally, memory resource 216 may be a portable, external or remote storage medium, for example, that causes computing device 202 to download the instructions 218, 220, 222 from the portable/external/remote storage medium,

The computing device 202 may include instructions 218 stored in the memory resource 216 and executable by the processor resource 214 to receive a call from an application to an API service of an OS of the computing device 202. The call can be, for example, a system call to request a service from the OS of the computing device 202 for the application.

The computing device 202 may include instructions 220 stored in the memory resource 216 and executable by the processor resource 214 to modify the call to the API service based on a policy. A policy can be a procedure that is to be taken if a condition is satisfied. A sensor included in the computing device can determine whether the condition is satisfied. A function provider included in the API service of the OS can hook the call and modify the call by filtering the call, altering the filtered call, and/or prioritizing a first content type over a second content type. The function provider in the API service of the OS can modify the call by adding a parameter and/or a flag to the call.

The computing device 202 may include instructions 222 stored in the memory resource 216 and executable by the processor resource 214 to return a modified output to the application according to the modified call based on the policy being active. For example, the call from the application can be hooked and modified in response to the policy being active and a modified output can be returned to the application. The application can execute according to the modified output, which can cause the behavior of the application to be modified (e.g., relative to the call from the application not being hooked and modified).

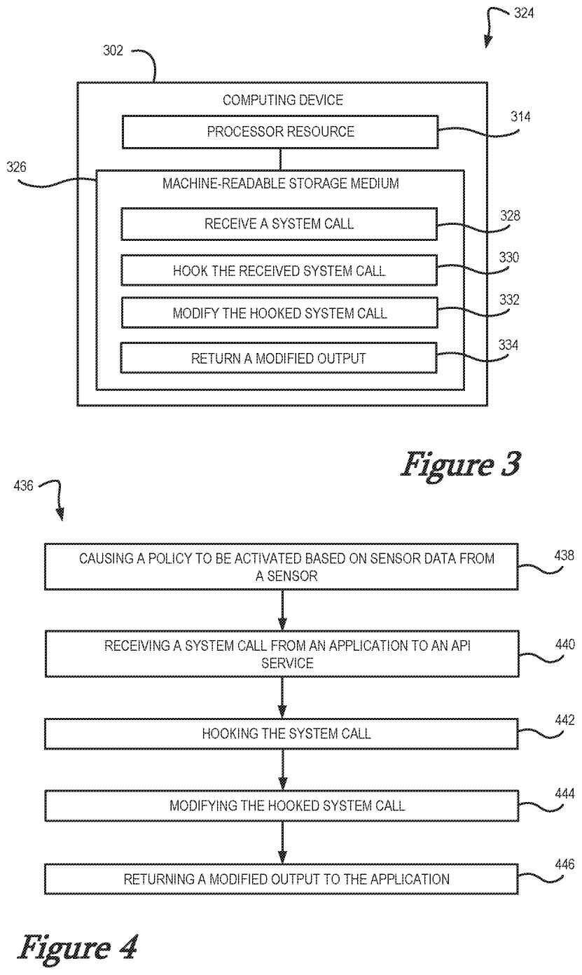

FIG. 3 illustrates a block diagram of an example system 324 for call modification based on policies. In the example of FIG. 3, system 324 includes a computing device 302 having a processor resource 314 and a non-transitory machine-readable storage medium 326. Although the following descriptions refer to a single processor resource and a single machine-readable storage medium, the descriptions are applicable to a system with multiple processors and multiple machine-readable storage mediums, In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processor resource 314 may be a central processing unit (CPU), microprocessor, and/or other hardware device suitable for retrieval and execution of instructions stored in machine-readable storage medium 326. In the particular example shown in FIG. 3, processor resource 314 may receive, determine, and send instructions 328, 330, 332, and 334. As an alternative or in addition to retrieving and executing instructions, processor resource 314 may include an electronic circuit comprising a number of electronic components for performing the operations of the instructions in machine-readable storage medium 326. With respect to the executable instruction representations or boxes described and shown herein, it should be understood that part or all of the executable instructions and/or electronic circuits included within one box may be included in a different box shown in the figures or in a different box not shown.

Machine-readable storage medium 326 may be any electronic, magnetic, optical, or other physical storage device that stores executable instructions. The executable instructions may be “installed” on the system 324 illustrated in FIG. 3, Machine-readable storage medium 326 may be a portable, external or remote storage medium, for example, that allows the system 324 to download the instructions from the portable/external/remote storage medium. In this situation, the executable instructions may be part of an “installation package”.

Receive a system call instructions 328, when executed by a processor such as processor resource 314, may cause system 324 to receive a system call from an application to an API service of an OS of the computing device 302. The call can be, for example, a system call to request a service from the OS of the computing device 302 for the application.

Hook the received system call instructions 330, when executed by a processor such as processor resource 314, may cause system 324 to hook the received system call to the API service by a function provider included in the API service of the OS. For example, the function provider can provide instructions to hook a system call received from the application in order to modify or augment the behavior of the application and/or the OS.

Modify the hooked system call instructions 332, when executed by a processor such as processor resource 314, may cause system 324 to modify the hooked system call to the API service based on an active policy. For example, the computing device 302 may include a sensor that can detect an event or change in an environment around the computing device 302 and based on the detected event or change in the environment around the computing device 302, cause a policy to be activated. In response to the policy being active, a function provider included in the API service of the OS can hook the system call and modify the system call by filtering the system call, altering the filtered system call, and/or prioritizing a first content type over a second content type. The function provider in the API service of the OS can modify the system call by adding a parameter and/or a flag to the call.

Return a modified output instructions 334, when executed by a processor such as processor resource 314, may cause system 324 to return a modified output to the application according to the modified system call based on the active policy. For example, the system call from the application can be hooked and modified in response to the policy being active and a modified output can be returned to the application. The application can execute according to the modified output, which can cause the behavior of the application to be modified (e.g., relative to the system call from the application not being hooked and modified).

FIG. 4 illustrates an example of a method 436 for call modification based on policies. For example, method 436 can be performed by a computing device (e.g., computing device 102, 202, 302, previously described in connection with FIGS. 1-3, respectively).

At 438, the method 436 includes causing, by a computing device, a policy to be activated based on sensor data from a sensor. For example, the computing device can include a sensor that can detect an event or change in an environment around the computing device and based on the detected event or change in the environment around the computing device, cause a policy to be activated.

At 440, the method 436 includes receiving, by the computing device, a system call from an application to an API service of an OS of the computing device. The call can be, for example, a system call to request a service from the OS of the computing device 302 for the application.

At 442, the method 436 includes hooking, by the computing device, the system call to the API service. For example, a function provider included in the API service of the OS can provide a instructions to hook a system call received from the application in order to modify or augment the behavior of the application and/or the OS.

At 444, the method 436 includes modifying, by the computing device, the hooked system call based on the policy. In response to the policy being active, the function provider included in the API service of the OS can hook the system call and modify the system call by filtering the system call, altering the filtered system call, and/or prioritizing a first content type over a second content type. The function provider in the API service of the OS can modify the system call by adding a parameter and/or a flag to the call.

At 446, the method 436 includes returning, by the computing device, a modified output to the application according to the modified system call based on the policy. For example, the system call from the application can be hooked and modified in response to the policy being active and a modified output can be returned to the application. The application can execute according to the modified output, which can cause the behavior of the application to be modified (e.g., relative to the system call from the application not being hooked and modified).

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A computing device, comprising:
a processor resource; and
a non-transitory memory resource storing machine-readable instructions to cause the processor resource to:
receive a call from an application to an application programming interface (API) service of an operating system (OS) of the computing device;
modify the call to the API service based on a policy; and
return a modified output to the application according to the modified call based on the policy being active.

2. The computing device of claim 1, wherein the processor resource is to modify the call to the API service by filtering the call.

3. The computing device of claim 2, wherein the processor resource is to modify the call to the API service by altering the filtered call.

4. The computing device of claim 2, wherein the processor resource is to transform the filtered call to the API service by prioritizing a first content type over a second content type.

5. The computing device of claim 1, wherein the computing device further includes a sensor to capture sensor data.

6. The computing device of claim 5, wherein the processor resource is to cause, based on the captured sensor data, the policy to be activated.

7. The computing device of claim 1, wherein the call is a system call.

8. A non-transitory machine-readable medium including instructions that when executed cause a processor resource to:
receive a system call from an application to an application programming interface (API) service of an operating system (OS) of the computing device;
hook the received system call to the API service by a function provider included in the API service of the OS;
modify the hooked system call to the API service based on an active policy; and
return a modified output to the application according to the modified system call based on the active policy.

9. The medium of claim 8, wherein the policy is one of a plurality of policies,

10. The medium of claim 9, wherein the processor resource is to receive an updated plurality of policies from a remote computing device.

11. The medium of claim 9, wherein:
the computing device includes a user account associated with the plurality of policies; and
the processor resource is to receive the plurality of policies in response to the user account accessing the computing device.

12. A method, comprising:
causing, by a computing device, a policy to be activated based on sensor data from a sensor;
receiving, by the computing device, a system call from an application to an application programming interface (API) service of an operating system (OS) of the computing device;
hooking, by the computing device, the system call to the API service;
modifying, by the computing device, the hooked system call based on the policy; and
returning, by the computing device, a modified output to the application according to the modified system call based on the policy.

13. The method of claim 12, wherein modifying the hooked system call includes adding a parameter to the hooked system call.

14. The method of claim 12, wherein modifying the hooked system call includes adding a flag to the hooked system call for a different API.

15. The method of claim 12, wherein the method includes causing the application to execute according to the modified output.
